(19) United States
(12) Patent Application Publication
(10) Pub. No.: US 2001/0026359 A1
(43) Pub. Date: Oct. 4, 2001

(54) Film carriers for printers and printers

(76) Inventor: Coles Raymond, Weymouth (GB)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/822,471

(22) Filed: Apr. 2, 2001

(30) Foreign Application Priority Data
Apr. 4, 2000 (GB) 0008287.5

(51) Int. Cl. G03B 27/52

(52) U.S. Cl. 355/75; 355/72; 355/40; 355/74; 355/41

(57) ABSTRACT

A film carrier is provided with markers for encoding information relating to the film, such that this information may be read by a printer.

### BACKGROUND OF THE INVENTION

1. Field of The Invention

The present invention relates to a film carrier for a printer and to a printer capable of reading indicia on the carrier.

2. Description of Related Art

Specialized printers, such as security card printers, may print one or more images onto a card or other substrate using a known printing process, such as a dye sublimation process. In order to protect the dye, a protective plastic layer is then deposited onto the surface of the substrate. Both the transfer of the dye and the deposition of the protective layer can be performed using a thermal printer. In these techniques, a dye, a resin wax, similar transferable pigments, and, optionally, the protective coating are transferred from a thin carrier film to a receiver media by means of thermal impulses from a thermal array print head. The thermal array print head often comprises a linear array of several hundred small heater elements in intimate contact with the carrier film. The pigmented surface of the film or the protective portion of the film is pressed into intimate contact with the receiver media.

When selected heater elements on the surface of the thermal print head are energized with short pulses of electrical energy, this raises their surface temperature to a value at which the pigment or the protective coating is transferred from the carrier film to the receiver media. Following this transfer, the carrier film and the receiver media are moved relative to the thermal print head by a distance equivalent to the diameter of the spot or by a distance equivalent to the width of the print head, whichever is appropriate. By the repeated sequence of applying heat impulses followed by media movement, any desired image may be built up.

Further, it is known that a faint image also may be formed in the protective coating itself such that this image is superimposed on the printed image. For example, this may be done by selectively overheating portions of the carrier film.

### SUMMARY OF THE INVENTION

According to a first aspect of the present invention, there is provided a film for a printer, in combination with a film carrier, wherein the carrier has at least one marker which is readable by the printer, such that the printer identifies the film and take a predetermined action. According to a second aspect of the present invention, there is provided a printer comprising at least one sensor for reading at least one marker provided on a film carrier used within the printer, such that the printer identifies the film and takes a predetermined action.

Thus, it is possible to provide a film, and a printer, which co-operates to identify the nature of the film loaded in the printer. Thus, for a printer which is capable of laying down a protective layer over a substrate, the marker indicates whether the film loaded in the printer includes a portion of the protective coating, or merely includes the pigments used in thermal printing. Thus, it is possible to prevent an operator from inadvertently instructing a printer to perform a task not supported by the film loaded therein.

The film, which term as used herein is intended to encompass any ink, dye, or transferable protective layer carried on or in a flexible elongate substrate, may be carried on a spool. The spool may carry one or more identifiers which are readable by the printer in order to identify the type of film, and optionally the supplier of the film.

This option of identifying the source or supplier of the film may be advantageous where nominally equivalent films may be sourced from a number of competing suppliers, but these are deemed to be a different quality or the printer manufacturer is prepared to warrant only approved suppliers, for example because these suppliers have submitted to a product evaluation and assessment program.

The at least one marker may be placed on, in, or inside the film carrier. The markers on the carrier may comprise colored portions, raised sections, apertures, slots, indentations or other shapes cut or punched into the carrier, patterns of holes or perforations or magnetic strips arranged so as to define a machine readable code identifying the film or the manufacturer, or both.

The carrier may be opaque. In which case, apertures may be formed in it to encode a light beam passing therethrough. Alternatively the carrier may be translucent. This has the advantage that opaque markings then may be printed onto the carrier to define the security code. As a further alternative markings for inspection in colored light need merely be distinguishable, either in terms of reflectivity or color, from the carrier.

In a preferred embodiment, an identity code similar to a bar code is printed around the external periphery of the carrier, and this is readable by a photo-detector located in the printer.

Advantageously the printer contains means for reading the identity code associated with the film and comparing this with pre-stored or down-loadable information in order to enable one or more printer operations.

For printers used in the generation of security products, such as security cards, each stock of film may be provided with a unique identity code. Upon loading into the printer, the printer may seek to phone a central security authority thereby confirming that the film and the printer are both supposed to be owned by the same entity.

Irrespective of whether an external check is made with a security authority or whether a printer merely relies on an internally held set of identity codes, certain functions of the printer may then be enabled or disabled depending on the identity of the film and the supplier. Furthermore, if the film is supplied from a non warranted source, the printer may record this in order that this may be flagged to the owners or repairers in the event that the printer fails through use of substandard film from a non-authorized source.

Thus, features such as depositing a sacrificial/protective layer may be enabled or disabled depending on the identity of the film loaded into the printer. Similarly, security features such as forming additional security images within the protective layer may be enabled or disabled depending upon the source and identity of the film.

Other objects, features, and advantages will be apparent to persons of ordinary skill in the relevant art in view of the following detailed description of the invention and the accompanying drawings.

### BRIEF DESCRIPTION OF THE DRAWINGS

The present invention will further be described, by way of example, with reference to the accompanying drawings, in which:

FIG. 1 schematically illustrates a film on a film carrier, wherein the carrier carries markers according to the present invention;

FIG. 2 schematically illustrates a section of film; and

FIG. 3 schematically illustrates an arrangement within a printer for reading the markers and relaying signals to a control data processor.

### DETAILED DESCRIPTION OF PREFERRED EMBODIMENTS

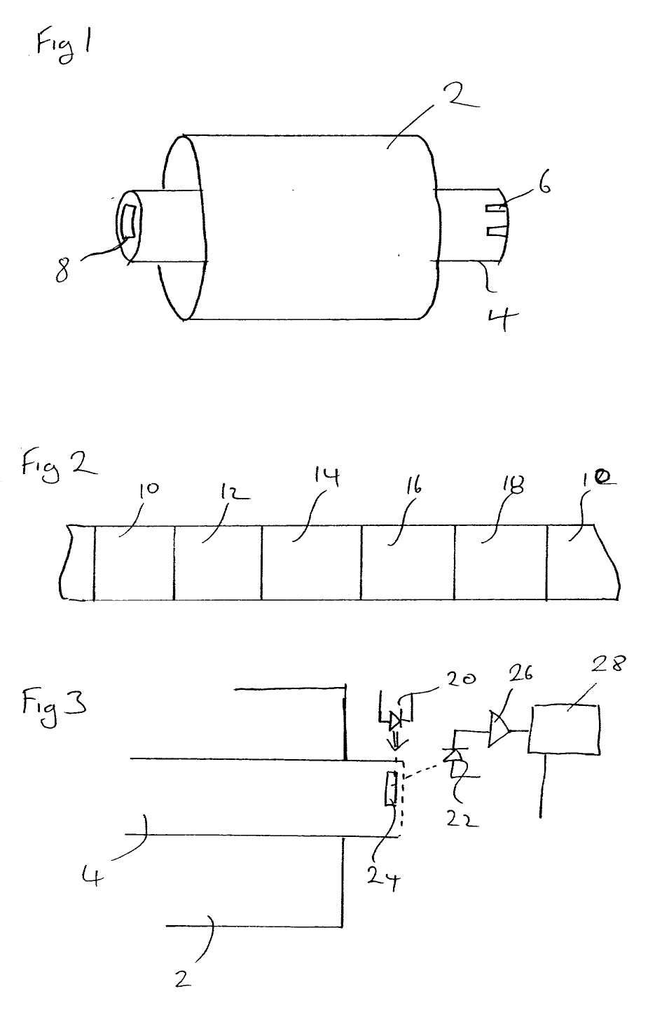

FIG. 1 schematically illustrates a roll of film in which a roll of film 2 is carried on a circular carrier 4. The carrier may have slots 6 or holes formed adjacent one end of the carrier such that these can be read by a detector as the carrier rotates with the film as the film is drawn off. Alternatively, a bar code 8 may be printed onto the interior or exterior surface of the carrier, or a magnetically readable element may be attached to the film.

Referring to FIG. 2, a film typically comprises a series of portions arranged in sequence. Thus, a first portion 10 may carry black pigment, a second portion 12 yellow pigment, a third portion 14 cyan and a fourth portion 16 magenta. A fifth portion 18 may carry a depositable layer of protective coating, and then the sequence may repeat. If the protective coating 18 is not provided, then the regions 10, 12, 14, and 16 may repeat in a contiguous manner. Thus, there is a need for the printer to identify the film type loaded in it in order to prevent an instruction to deposit the protective coating 18 from being implemented when no such layer is actually provided.

FIG. 3 schematically illustrates an embodiment of the present invention in which a film 2 on the carrier 4 is loaded in a printer. A light source 20, such as a light emitting diode is provided adjacent the end of the carrier 2. A photo-detector 22, such as a photo diode is arranged to receive light reflected from a coding portion 24 printed on the carrier 4. Imaging elements such as lenses and a collimating system associated with the photo-detector 22 are omitted for clarity. An output of the photo-detector 22 is connected to an input of an comparator 26. An output of the comparator 26 is connected to an input of a control data processor 28 which may serve to control the operations of the printer. Once a film is loaded, the film is rotated in order to scan the coding portion 24 past the light source and photo-detector in order that the code thereon may be read. This scanning operation may be initiated by the closing of a loading door on the printer, and may also be repeated at power up, and if desired, at predetermined intervals. Code 24, which conveniently may be a bar code is fed to the data processor where the code is decoded and compared with a list of film types and optionally film manufacturers. Upon the basis of this comparison, the data processor 28 can identify the film loaded an enable or disable certain features of the printer as appropriate. It also may set or reset flags within reserved memory within the printer to indicate to service personnel whether approved or non-approved films have been used in the printer.

In an alternative to this, the carrier 4 is translucent and the light source 20 and photodetector 22 are arranged facing each other such that the carrier 4 is interposed between them. In this arrangement the light source, for example, may be mounted close to the axis of the carrier 4 and may shine radially outwardly.

Thus, it is possible to provide an apparatus for automatically setting up a printer to accept the film type. Other data carriers instead of bar codes may be used, and in particular magnetic stripes may be formed within the body of the carrier 4, thereby making it more difficult to falsify the code in an attempt to defeat the identification system within the printer.

While the invention has been described in connecting with preferred embodiments, it will be understood by those of ordinary skill in the art that other variations and modifications of the preferred embodiments described above may be made without departing from the scope of the invention. Other embodiments also will be apparent to those of ordinary skill in the art from practice of the invention disclosed herein. It is intended that the specification and the described examples are considered as exemplary only, with the true scope of the invention indicated by the following claims.

What is claimed is:

1. A film for a printer in combination with a film carrier, wherein the carrier has at least one marker which is readable by a printer, such that the printer identifies the film and take a predetermined action.

2. The film and carrier combination of claim 1, in which said at least one marker is optically readable.

3. The film and carrier combination of claim 2, in which said at least one marker comprises an item selected from the group consisting of raised sections, apertures, slots, and indentations formed in the film carrier, patterns of holes, and magnetic strips.

4. The film and carrier combination of claim 2, in which said at least one marker comprises opaque markings on the carrier.

5. The film and carrier combination of claim 2, in which said at least one marker has a color different to that of the carrier.

6. The film and carrier combination of claim 2, in which said at least one marker has a reflectivity different to that of the carrier.

7. The film and carrier combination of claim 1, in which said at least one marker is a bar code.

8. A printer comprising a film for a printer in combination with a film carrier, wherein the carrier has at least one marker which is readable by a printer, such that the printer identifies the film and take a predetermined action.

9. The printer of claim 8, further comprising a reader for reading the marker and a data processor for analyzing the information conveyed by the marker and taking a predetermined action.

10. The printer of claim 9, in which the printer undertakes a security check to confirm the film is from an authorized source.

11. The printer of claim 9, in which the data processor enables or disables selected printer functions in response to the information conveyed by the marker.

12. The printer of claim 10, in which the data processor enables or disables selected printer functions in response to the information conveyed by the marker.

13. The printer as claimed in claim 7, in which the printer is a printer for printing security products.

14. The printer as claimed in claim 9, in which the printer undertakes a security check to confirm that the film is possessed by an authorized user.

15. The printer as claimed in claim 10, in which the printer undertakes a security check to confirm that the film is possessed by an authorized user.
